(19) United States
(12) Patent Application Publication
(10) Pub. No.: US 2018/0341389 A1
(43) Pub. Date: Nov. 29, 2018

(54) METHOD OF DISPLAYING CONTENTS AND ELECTRONIC DEVICE THEREOF

(71) Applicant: Samsung Electronics Co., Ltd., Gyeonggi-do (KR)

(72) Inventors: Harim KIM, Gyeonggi-do (KR); Na-Kyoung LEE, Gyeonggi-do (KR); Na-Young KIM, Seoul (KR); Min-Sung LEE, Gyeonggi-do (KR); Hyunsoo KIM, Gyeonggi-do (KR); Dong-Hyun YEOM, Gyeonggi-do (KR); Chang-Ryong HEO, Gyeonggi-do (KR)

(21) Appl. No.: 15/987,259

(22) Filed: May 23, 2018

(30) Foreign Application Priority Data
May 23, 2017 (KR) 10-2017-0063359

(51) Int. Cl. G06F 3/0484; G06F 3/0488; G06K 9/00; G06F 21/32; G06F 1/32

(52) U.S. Cl. CPC G06F 3/04842; G06F 3/0488; G06K 9/0004; G06F 3/04817; G06F 1/3265; G06F 2203/04803; G06F 21/32

(57) ABSTRACT

An electronic device and method thereof are provided for displaying content. The electronic device includes a display, a biometric sensor disposed in at least a partial area of the display and at least one processor configured to identify attribute information associated with an event generated while the electronic device operates in a low-power display mode, display a graphic object corresponding to the event on the partial area when the attribute information satisfies a designated condition, receive a user input on the graphic object via the display, obtain biometric information corresponding to the user input using the biometric sensor, and provide at least one content corresponding to the event when the biometric information is authenticated.

### CROSS-REFERENCE TO RELATED APPLICATION(S)

This application is based on and claims priority under 35 U.S.C. § 119(a) to Korean Patent Application Serial No. 10-2017-0063359, which was filed on May 23, 2017, in the Korean Intellectual Property Office, the disclosure of which is incorporated by reference herein in its entirety.

### BACKGROUND

### 1. Field

The disclosure relates, generally, to an electronic device, and more particularly, to an electronic device that uses a method for displaying a content in a low-power state.

### 2. Description of Related Art

Various types of electronic devices have been developed into multimedia devices that provide various multimedia services, such as a voice call service, a messenger service, a broadcasting service, a wireless internet service, a camera service, a music reproduction service, and the like.

The electronic devices are also configured to provide various user interfaces to users. For example, an electronic device can provide a lock function in which user authentication information (e.g., fingerprint information, pattern information, password information, iris information, or the like) can input.

When the lock function is set, an electronic device may operate in a low-power display mode that provides various contents to a user via a display while a processor (e.g., an application processor (AP)) can be maintained in a sleep state. For example, the electronic device may output a designated content using an always-on-display function.

### SUMMARY

The present disclosure has been made to address at least the disadvantages described above and to provide at least the advantages described below.

According to an aspect of the disclosure, there is provided an electronic device that may output an execution screen associated with a content that can be selected based on an input. When a lock function is set, the electronic device can perform an authentication operation for releasing the lock function.

In accordance with an aspect of the disclosure, there is provided an electronic device. The electronic device includes a display, a biometric sensor disposed in at least a partial area of the display and at least one processor configured to identify attribute information associated with an event generated while the electronic device operates in a low-power display mode, display a graphic object corresponding to the event on the partial area when the attribute information satisfies a designated condition, receive a user input on the graphic object via the display, obtain biometric information corresponding to the user input using the biometric sensor, and provide at least one content corresponding to the event when the biometric information is authenticated.

In accordance with an aspect of the disclosure, there is provided an electronic device. The electronic device includes a display comprising a biometric sensor for obtaining biometric information in a designated area and at least one processor electrically connected to a memory and configured to detect an event while the electronic device operates in a low-power display mode and display a graphic object corresponding to the event using the designated area when the event satisfies a designated condition.

In accordance with an aspect of the disclosure, there is provided a method of an electronic device. The method includes detecting an event occurring while the electronic device operates in a low-power display mode and displaying a graphic object corresponding to the event using a designated area of a display, of the electronic device, comprising a biometric sensor for obtaining biometric information when the event satisfies a designated condition.

In accordance with an aspect of the disclosure, there is provided a non-transitory computer readable medium having instructions stored thereon that when executed cause a processor to detect an event while the electronic device operates in a low-power display mode and display a graphic object corresponding to the event using the designated area when the event satisfies a designated condition.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram of an electronic device in a network environment, according to an embodiment;

FIG. 1B is a diagram of an electronic device for displaying a content, according to an embodiment;

FIG. 2 is a diagram of an electronic device, according to an embodiment;

FIG. 3 is a diagram of a program module, according to an embodiment;

FIG. 4 is a flowchart of a method in which an electronic device displays a content, according to an embodiment;

FIGS. 5A to 5C are diagrams of an area of a display where a notification object corresponding to an event is output, according to an embodiment;

FIG. 6 is a flowchart of a method in which an electronic device executes a low-power display mode, according to an embodiment;

FIG. 7 is a diagram of an output area of a content designated to be output via a low-power display mode, according to an embodiment;

FIG. 8A is a flowchart of a method in which an electronic device identifies an output area of an event notification object, according to an embodiment;

FIG. 8B is a diagram of an output area of an event notification object, according to an embodiment;

FIG. 9 is a flowchart of a method in which an electronic device processes an event notification object, according to an embodiment;

FIG. 10 is a diagram of processing a notification object that does not require authentication, according to an embodiment;

FIG. 11 is a flowchart of a method in which an electronic device processes an event notification object that requires authentication, according to an embodiment;

FIGS. 12A and 12B are diagrams of processing a notification object that requires authentication, according to an embodiment;

FIG. 13 is a flowchart of a method in which an electronic device controls an execution screen, according to an embodiment;

FIG. 14 is a diagram of a screen output based on input on an execution screen, according to an embodiment;

FIG. 15 is a flowchart of procedure method in which an electronic device controls an execution screen, according to an embodiment;

FIG. 16 is a diagram of a screen output based on input on an execution screen, according to an embodiment;

FIG. 17 is a flowchart of a method in which an electronic device controls an execution screen; and

FIG. 18 is a diagram of an execution screen that is output, according to an embodiment.

### DETAILED DESCRIPTION

Embodiments of the disclosure will be described herein below with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the disclosure.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the disclosure may include at least one of an application-specific integrated circuit (ASIC) chip, a field-programmable gate array (FPGA), and a programmable-logic device for performing operations which has been known or are to be developed hereinafter.

An electronic device according to the disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

The electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automatic teller machine (ATM) in banks, point of sales (POS) devices in a shop, or an Internet of things device (IoT) (e.g., a light bulb, various sensors, electric or gas meter, a sprinkler device, a fire alarm, a thermostat, a streetlamp, a toaster, a sporting goods, a hot water tank, a heater, a boiler, etc.).

The electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include an electronic device according to the development of new technology.

Hereinafter, an electronic device will be described with reference to the accompanying drawings. In the disclosure, the term “user” may indicate a person using an electronic device or a device (e.g., an artificial intelligence electronic device) using an electronic device.

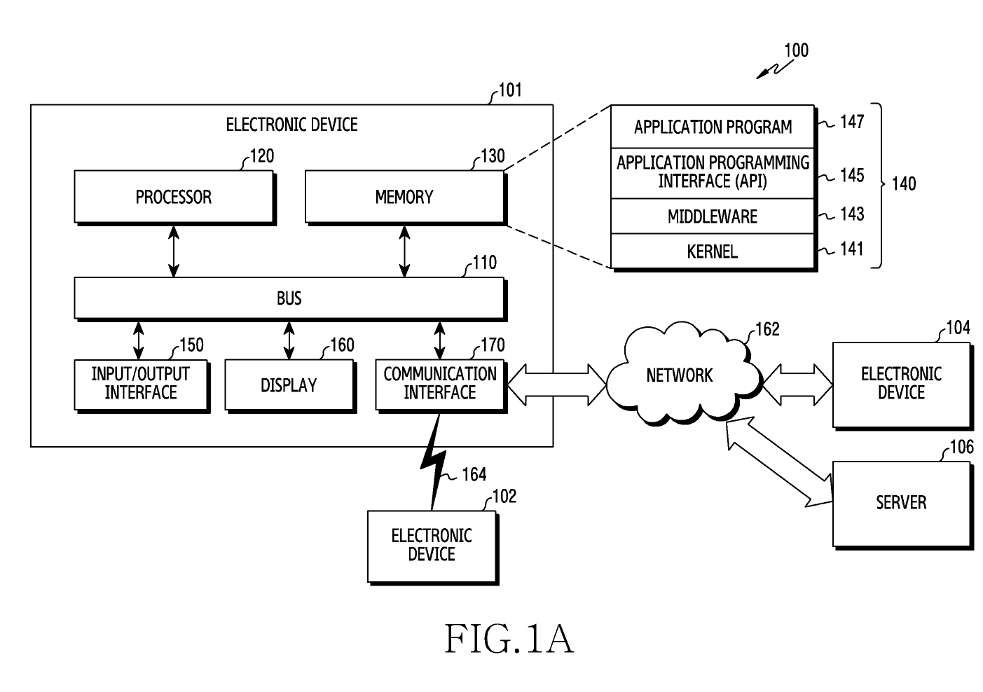

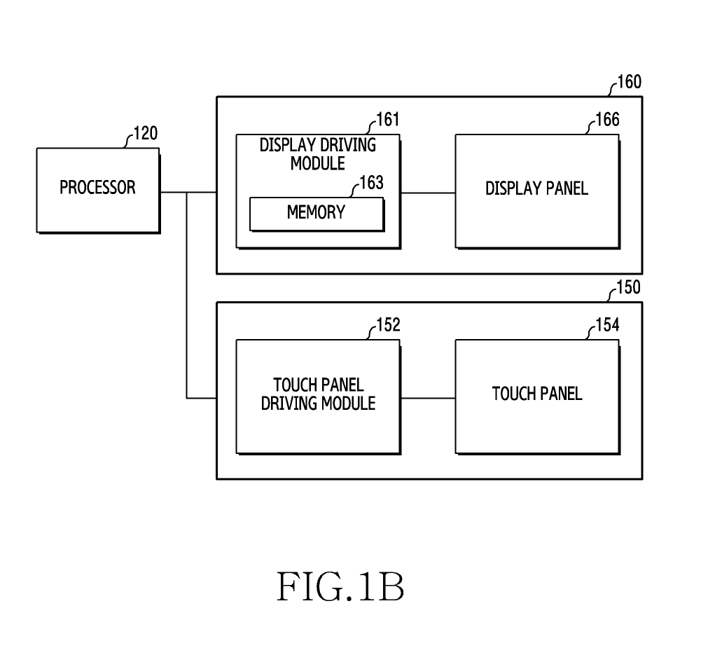

FIG. 1A is diagram of a network environment system, according to an embodiment.

Referring to FIG. 1A, an electronic device 101 within a network environment 100 is described. The electronic device 101 includes a bus 110, a processor 120, a memory 130, an input output interface 150, a display 160, and a communication interface 170. The electronic device 101 may omit at least one of the constituent elements or additionally have another constituent element. The bus 110 may include a circuit coupling the constituent elements 110, 120, 150, 160 and 170 with one another and forwarding communication (e.g., a control message or data) between the constituent elements. The processor 120 may include one or more of a central processing unit (CPU), an AP or a communication processor (CP). The processor 120 may execute operation or data processing for control and/or communication of at least one another constituent element of the electronic device 101.

The memory 130 may include a volatile and/or non-volatile memory. The memory 130 may store a command or data related to at least one another constituent element of the electronic device 101. The memory 130 may store a software and/or program 140. The program 140 may include a kernel 141, a middleware 143, an application programming interface (API) 145, an application program (application) 147, and the like. At least some of the kernel 141, the middleware 143 or the API 145 may be called an operating system (OS). The kernel 141 may control or manage system resources (e.g., bus 110, processor 120, memory 130, and the like) that are used for executing operations or functions implemented in other programs (e.g., middleware 143, API 145 or application 147). Also, the kernel 141 may provide an interface through which the middleware 143, the API 145 or the application 147 may control or manage the system resources of the electronic device 101 by accessing the individual constituent element of the electronic device 101.

The middleware 143 may perform a relay role of enabling the API 145 or the application 147 to communicate and exchange data with the kernel 141. Also, the middleware 143 may process one or more work requests that are received from the application 147, in accordance with priority. The middleware 143 may grant priority capable of using the system resources (e.g., the bus 110, the processor 120, the memory 130 or the like) of the electronic device 101 to at least one of the applications 147, and process one or more work requests. The API 145 can be an interface enabling the application 147 to control a function provided by the kernel 141 or the middleware 143 and may include at least one interface or function (e.g., an instruction) for file control, window control, image processing, character control or the like.

The input output interface 150 may forward a command or data inputted from a user or another external device, to another constituent element(s) of the electronic device 101, or output a command or data received from the another constituent element(s) of the electronic device 101, to the user or another external device. The input output interface 150 may include a physical button such as a home button, a power button, a volume control, etc. as well. The input output interface 150 may include a speaker for outputting an audio signal and a microphone for sensing the audio signal or the like.

The display 160 may include a liquid crystal display (LCD), a light emitting diode (LED) display, an organic light emitting diode (OLED) display, a microelectromechanical systems (MEMS) display or an electronic paper display. The display 160 may display various contents (e.g., a text, an image, a video, an icon, a symbol and/or the like) to a user. The display 160 may include a touch screen, and may receive a touch, gesture, proximity or hovering input that uses an electronic pen or a part of the user's body.

The communication interface 170 may establish communication between the electronic device 101 and a first external electronic device 102, a second external electronic device 104 or a server 106. The communication interface 170 may be coupled to a network 162 through wireless communication or wired communication, to communicate with the second external electronic device 104 or the server 106.

The wireless communication may include a cellular communication that uses at least one of long term evolution (LTE), LTE-advanced (LTE-A), code division multiple access (CDMA), wideband CDMA (WCDMA), universal mobile telecommunications system (UMTS), wireless broadband (WiBro), global system for mobile communications (GSM) and the like. The wireless communication may include at least one of wireless-fidelity (WiFi), bluetooth (BT), BT low energy (BLE), Zigbee, near field communication (NFC), magnetic secure transmission (MST), radio frequency (RF) or body area network (BAN). The wireless communication may include GNSS, and the GNSS may be a global positioning system (GPS), a global navigation satellite system (Glonass), Beidou navigation satellite system (Beidou) or Galileo, the European global satellite-based navigation system. Hereinafter, the GPS may be used interchangeably with the GNSS. The wired communication may include at least one of a universal serial bus (USB), a high definition multimedia interface (HDMI), a recommended standard-232 (RS-232), power line communication (PLC), a plain old telephone service (POTS), and the like. The network 162 may include at least one of a telecommunications network, for example, a computer network (e.g., local area network (LAN) or wide area network (WAN)), the Internet or a telephone network.

Each of the first and second electronic devices 102 and 104 may be a device of the same or different type from that of the electronic device 101. All or some of operations executed in the electronic device 101 may be executed in the electronic devices 102 and 104 or the server 106. When the electronic device 101 performs some function or service automatically or in response to a request, the electronic device 101 may, instead of or additionally to executing the function or service in itself, send a request for execution of at least a partial function associated with electronic device 102, 104 or server 106. The electronic device 102, 104 or server 106 may execute the requested function or additional function, and forward the execution result to the electronic device 101. The electronic device 101 may process the received result as is or provide the requested function or service using cloud computing, distributed computing or client-server computing technology.

FIG. 1B is a diagram of the electronic device 101 for displaying a content, according to an embodiment.

Referring to FIG. 1B, the electronic device 101 may include the processor 120, the display 160, and the input/output interface 150.

The processor 120 may perform an operation associated with a low-power display mode. For example, the low-power display mode may be a mode in which a predetermined content is output via the display 160 while the processor 120 is maintained in a sleep state. The low-power display mode may include an always-on-display state. The processor 120 may transfer, to a display driving module 161, a content designated to be output in the low-power display mode (e.g., an icon, an image, time information, weather information, date information, words designated by a user, schedule information, or the like) and output information of the content (e.g., an output location, font information of various characters, an update period, or the like). Based on attribute information of a designated content, the processor 120 may determine at least the output location (or output area) of the content. The attribute information may be associated with the security level of the content. The security level may include a level at which authentication is required for execution of the content. A content that requires authentication (e.g., a content having attribute information that satisfies a designated condition (e.g., a content having a security level)) for execution of the content may be displayed on a designated area (e.g., a first area) of the display 160. The designated area of the display 160 may be an area where a sensor for obtaining biometric information is disposed. Also, a content that does not require authentication (e.g., a content having attribute information that does not satisfy a designated condition (e.g., a content having a non-security level)) for execution of the content may be displayed on another designated area (e.g., a second area) of the display 160. The other designated area of the display 160 may be an exclusive area from the designated area of the display 160. The processor 120 may transfer a content designated in advance and the output information of the content to the display driving module 161 before the low-power mode is executed or while the low-power mode is executed. The processor 120 may maintain a sleep state while the low-power display mode is executed.

The processor 120 may detect the occurrence of an event while the low-power display mode is executed. The event may be generated by the electronic device 101 or may be received from an external device. The event that is generated by the electronic device 101 or is received from an external device may be associated with reception of a message, reception of an e-mail, a missed call, and a schedule alarm. In response to detection of the occurrence of an event, the state of the processor 120 may be switched from a sleep state to a wake-up state. The processor 120, which is switched to the wake-up state, may output a notification object (e.g., an icon, an image, text, or the like) that represents the detected event via the low-power display mode. The processor 120 may transfer the notification object corresponding to the event and the output information of the notification object (e.g., the output location of the notification object) to the display driving module 161.

The processor 120 may determine the output location of the notification object based on the attribute information of the detected event. The attribute information may be associated with the security level of the detected event. The security level may include a level at which authentication is required for identifying the event. An event that requires authentication (e.g., an event having attribute information that satisfies a designated condition (e.g., an event having a security level)) when the event is identified may be displayed on a designated area (e.g., a first area) of the display 160. Also, an event that does not require authentication (e.g., an event having attribute information that does not satisfy a designated condition (e.g., an event having a non-security level)) when the event is identified may be displayed on another designated area (e.g., a second area) of the display 160.

The processor 120 may receive input for selecting an output content or notification object, while the low-power display mode is executed. In response to the input for selecting the output content or notification object, the state of the processor 120 may be switched from the sleep state to the wake-up state.

When the input for selecting the output content or notification object is received, a content corresponding to the selected content or notification object is output. The content corresponding to the notification object may be an execution screen of the event. The processor 120 may determine an output scheme of an execution screen based on the output location of the selected content or notification object. The output location of the selected content or notification object may include a first area of the display 160 and a second area of the display 160. When a content or notification object output to the first area of the display 160 is selected, the processor 120 may, output the execution screen of a first mode. The execution screen of the first mode may be an execution screen output via the low-power display mode. Also, when a content or notification object output to the second area of the display 160 is selected, the processor 120 may output the execution screen of a second mode. The execution screen of the second mode may be an execution screen that is output in the state in which the low-power display mode is canceled. The state in which the low-power display mode is canceled may be a state in which a predetermined authentication operation is completed.

The display 160 may include the display driving module 161 and a display panel 166. The display driving module 161 may drive the display panel 166. The display driving module 161 may provide, to the display panel 166, an image signal corresponding to a content and/or a notification object stored in a memory 163 or the memory 130 (e.g., a graphic random access memory (RAM)) of the display 160 (or the display driving module 161) using a predetermined number of frames. The display driving module 161 may provide an image signal to the display panel 166 such that the content and/or notification object that does not require authentication for execution is output to the first area of the display 160. Also, the display driving module 161 may provide an image signal to the display panel 166 such that the content and/or notification object that requires authentication for execution is output to the second area of the display 160. The display driving module 161 may include a display driver integrated circuit (DDI).

The input/output interface 150 may include a touch panel driving module 152 and a touch panel 154. The touch panel driving module 152 may receive input for selecting a content or a notification object via the touch panel 154. Also, the touch panel driving module 152 may transfer information associated with the received input (e.g., coordinate information) to the processor 120.

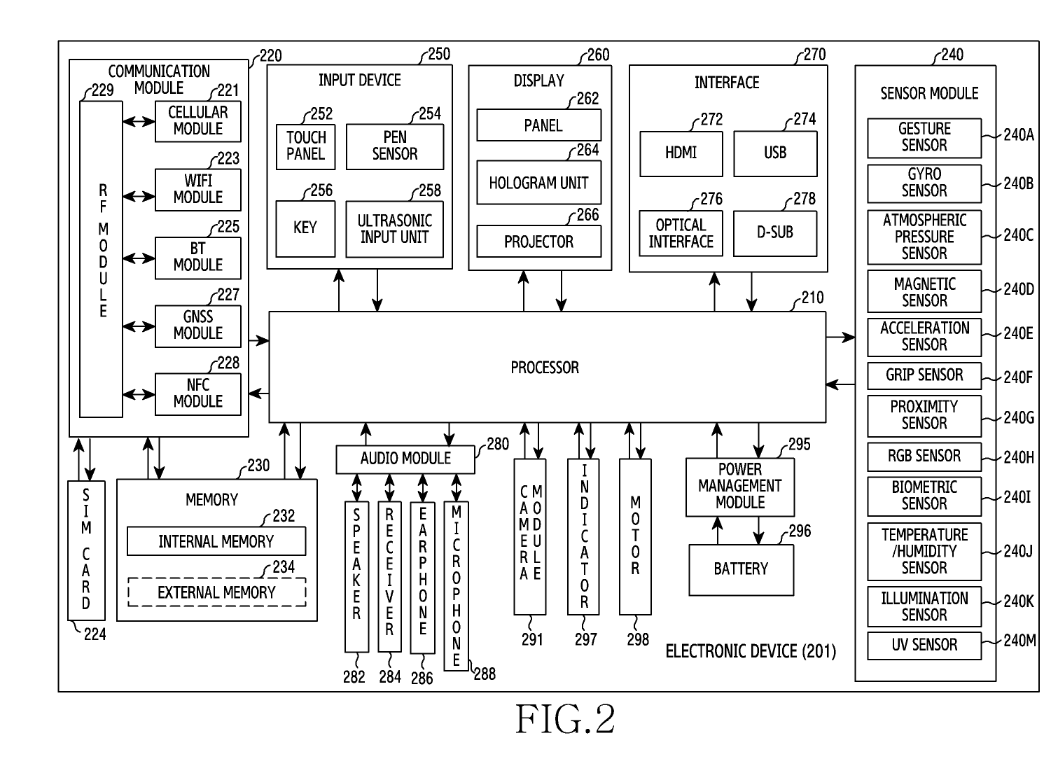

FIG. 2 is a diagram of an electronic device, according to an embodiment.

Referring to FIG. 2, an electronic device 201 may include all or part of the electronic device 101 illustrated in FIG. 1A. The electronic device 201 includes one or more processors (e.g., APs) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may drive an OS or an application program to control a majority of hardware or software constituent elements coupled to the processor 210, and may perform various data processing and operations. The processor 210 may be implemented as a system on chip (SoC). The processor 210 may further include a graphic processing unit (GPU) and/or an image signal processor (ISP). The processor 210 may include at least some (e.g., cellular module 221) of the constituent elements illustrated in FIG. 2. The processor 210 may load a command or data received from at least one of the other constituent elements (e.g., non-volatile memory), to a volatile memory, to process the loaded command or data, and store the result data in the non-volatile memory.

The communication module 220 may have the same or similar construction as the communication interface 170. The communication module 220 includes a cellular module 221, a WiFi module 223, a BT module 225, a GNSS module 227, an NFC module 228, and a radio frequency (RF) module 229. The cellular module 221 may provide voice telephony, video telephony, a text service, an Internet service or the like through a telecommunication network. The cellular module 221 may perform the distinction and authentication of the electronic device 201 within the telecommunication network, by using the SIM 224. The cellular module 221 may perform at least some functions among functions that the processor 210 may provide. The cellular module 221 may include a CP. At least some (e.g., two or more) of the cellular module 221, the WiFi module 223, the BT module 225, the GNSS module 227 or the NFC module 228 may be included within one integrated chip (IC) or IC package. The RF module 229 may transceive a communication signal (e.g., RF signal).

The RF module 229 may include a transceiver, a power amplifier module (PAM), a frequency filter, a low noise amplifier (LNA), an antenna or the like. At least one of the cellular module 221, the WiFi module 223, the BT module 225, the GNSS module 227 or the NFC module 228 may transceive an RF signal through a separate RF module. The SIM 224 maybe an embedded SIM. And, the SIM 224 may include unique identification information (e.g., integrated circuit card identifier (ICCID)) or subscriber information (e.g., international mobile subscriber identity (IMSI)).

The memory 230 includes an internal memory 232 and/or an external memory 234. The internal memory 232 may include at least one of a volatile memory (e.g., a dynamic RAM (DRAM), a static RAM (SRAM), a synchronous dynamic RAM (SDRAM) or the like) and a non-volatile memory (e.g., one time programmable read only memory (OTPROM), a programmable ROM (PROM), an erasable PROM (EPROM), an electrically EPROM (EEPROM), a mask ROM, a flash ROM, a flash memory, a hard drive or a solid state drive (SSD)). The external memory 234 may include a flash drive, for example, a compact flash (CF), a secure digital (SD), a micro-SD, a mini-SD, an extreme Digital (xD), a multimedia card (MMC), a memory stick or the like. The external memory 234 may be operatively or physically coupled with the electronic device 201 through various interfaces.

The sensor module 240 may measure a physical quantity or sense an activation state of the electronic device 201, to convert measured or sensed information into an electrical signal. The sensor module 240 includes a gesture sensor 240A, a gyro sensor 240B, a barometer 240C, a magnetic sensor 240D, an acceleration sensor 240E, a grip sensor 240F, a proximity sensor 240G, a color sensor 240H (e.g., a red, green, blue (RGB) sensor), a biometric (medical) sensor 240I, a temperature/humidity sensor 240J, an ambient light (illuminance) sensor 240K, and an ultra violet (UV) sensor 240M. Additionally or alternatively, the sensor module 240 may, for example, include an e-nose sensor, an electromyography (EMG) sensor, an electroencephalogram (EEG) sensor, an electrocardiogram (ECG) sensor, an infrared (IR) sensor, an iris scan sensor and/or a finger scan sensor. The sensor module 240 may further include a control circuit for controlling at least one or more sensors belonging therein. The electronic device 201 may further include a processor configured to control the sensor module 240 as a part of the processor 210 or separately, thereby controlling the sensor module 240 while the processor 210 is in a sleep state.

The input device 250 may include a touch panel 252, a (digital) pen sensor 254, a key 256 or an ultrasonic input device 258. The touch panel 252 may use at least one scheme among a capacitive overlay scheme, a pressure sensitive scheme, an infrared beam scheme or an ultrasonic scheme. Also, the touch panel 252 may include a control circuit, and a tactile layer, to provide a tactile response to a user. The (digital) pen sensor 254 maybe a part of the touch panel 252, or include a separate sheet for recognition. The key 256 may include a physical button, an optical key or a keypad. The ultrasonic input device 258 may sense an ultrasonic wave generated in an input tool, through a microphone 288, to confirm data corresponding to the sensed ultrasonic wave.

The display 260 may include a panel 262, a hologram device 264, a projector 266, a display driver interface (DDI) (not illustrated), and/or a control circuit for controlling them. The panel 262 may be implemented to be flexible, transparent, or wearable. The panel 262 may be constructed as one or more modules together with the touch panel 252. The hologram device 264 may show a three-dimensional image to the air using an interference of light. The projector 266 may project light onto a screen, to display an image. The screen may be located inside or outside the electronic device 201. The interface 270 may include an HDMI 272, a USB 274, an optical interface 276 or a d-subminiature (D-sub) 278. The interface 270 may be included in the communication interface 170 illustrated in FIG. 1A. Additionally or alternatively, the interface 270 may include a mobile high-definition link (MHL) interface, an SD card/MMC interface or an Infrared data Association (IrDA) standard interface.

The audio module 280 may convert a sound and an electrical signal interactively. At least some constituent elements of the audio module 280 may be included in the input output interface 150 illustrated in FIG. 1A. The audio module 280 may process sound information that is inputted or outputted through a speaker 282, a receiver 284, an earphone 286, the microphone 288 or the like.

The camera module 291 is a device able to photograph a still image and a video. The camera module 291 may include one or more image sensors (e.g., front sensor or rear sensor), a lens, an ISP or a flash (e.g., an LED, a xenon lamp or the like). The power management module 295 may manage the electric power of the electronic device 201. The power management module 295 may include a power management integrated circuit (PMIC), a charger IC or a battery gauge. The PMIC may employ a wired and/or wireless charging scheme. The wireless charging scheme may include a magnetic resonance scheme, a magnetic induction scheme, an electromagnetic wave scheme or the like. The wireless charging scheme may further include a supplementary circuit for wireless charging, for example, a coil loop, a resonance circuit, a rectifier or the like. The battery gauge may measure a level of the battery 296, a voltage being in charge, an electric current or a temperature. The battery 296 may include a rechargeable battery and/or a solar battery.

The indicator 297 may display a specific state, for example, a booting state, a message state, a charging state or the like of the electronic device 201 or a part (e.g., processor 210) of the electronic device 201. The motor 298 may convert an electrical signal into a mechanical vibration, and may generate a vibration, a haptic effect or the like. The electronic device 201 may include a mobile TV support device (e.g., GPU) capable of processing media data according to the standards of digital multimedia broadcasting (DMB), digital video broadcasting (DVB), MediaFlo™ or the like.

Each of the constituent elements described herein may consist of one or more components, and a name of the corresponding constituent element may be varied according to the kind of the electronic device 201. The electronic device 201 may omit some constituent elements, or further include additional constituent elements, or combine some of the constituent elements to configure one entity, but identically perform functions of corresponding constituent elements before combination.

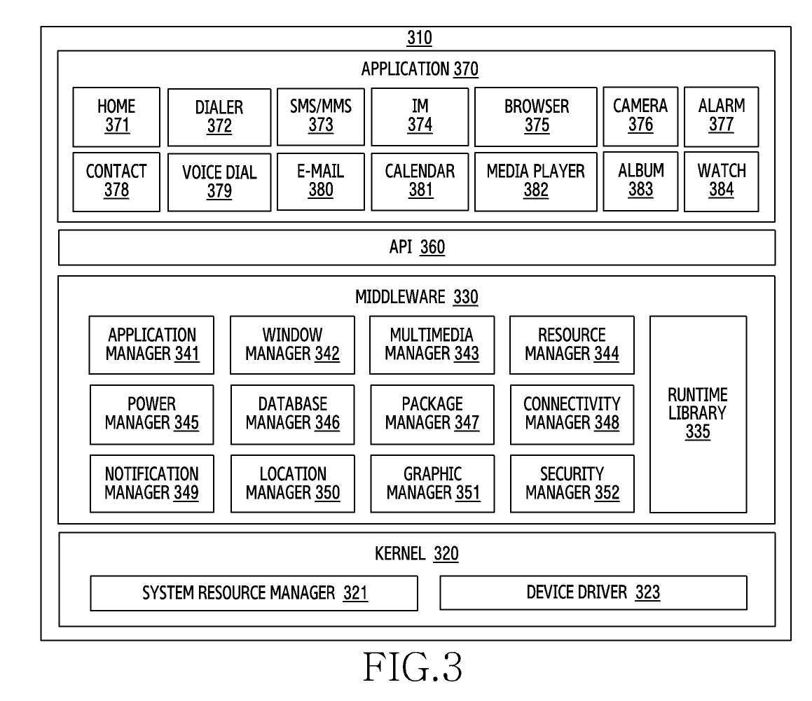

FIG. 3 is a diagram of a program module, according to an embodiment.

A program module 310 may include an OS controlling resources related to an electronic device (e.g., the electronic device 101/201) and/or various applications (e.g., the application 147) run on the OS. The OS may include Android™, iOS™, Windows™, Symbian™, Tizen™, or Bada™.

Referring to FIG. 3, the program module 310 includes a kernel 320, a middleware 330, an API 360, and/or an application 370. At least a part of the program module 310 may be preloaded onto an electronic device, or be downloadable from an external electronic device (e.g., the electronic device 102 or 104, the server 106, etc.).

The kernel 320 includes a system resource manager 321 and/or a device driver 323. The system resource manager 321 may control a system resource, allocation thereof, or recovery thereof. The system resource manager 321 may include a process management unit, a memory management unit, or a file system management unit. The device driver 323 may include a display driver, a camera driver, a BT driver, a shared memory driver, a USB driver, a keypad driver, a WiFi driver, an audio driver, or an inter-process communication (IPC) driver. The middleware 330 may provide a function required in common by the application 370, or provide various functions to the application 370 through the API 360, wherein the application 370 may make use of restricted system resources within an electronic device. The middleware 330 includes a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module that a compiler utilizes to add a new function through a programming language while the application 370 is executed. The runtime library 335 may perform input output management, memory management, or arithmetic function processing. The application manager 341 may manage a lifecycle of the application 370. The window manager 342 may manage a GUI resource which is used for a screen. The multimedia manager 343 may obtain a format used for playing media files, and perform encoding or decoding of the media file by using a codec suitable to the corresponding format. The resource manager 344 may manage a source code of the application 370 or a space of a memory. The power manager 345 may manage a battery capacity, temperature or power supply, and identify or provide power information used for an operation of an electronic device by using corresponding information.

The power manager 345 may interwork with a basic input/output system (BIOS). The database manager 346 may provide, search or change a database that will be used in the application 370. The package manager 347 may manage the installing or refining of an application that is distributed in the form of a package file.

The connectivity manager 348 may manage wireless connectivity. The notification manager 349 may provide an event such as an arrival message, an appointment, a proximity notification, etc. to a user. The location manager 350 may manage location information of an electronic device. The graphic manager 351 may manage a graphic effect that will be provided to the user, or a user interface related with this. The security manager 352 may provide system security or user authentication. The middleware 330 may include a telephony manager for managing a voice or video call function of the electronic device, or a middleware module capable of forming a combination of functions of the aforementioned constituent elements. The middleware 330 may provide a module that is specialized by type of an OS. The middleware 330 may dynamically delete some of the existing constituent elements, or add new constituent elements.

The API 360 is a set of API programming functions, and may be provided to have another construction according to the operating system. For example, in Android™ or iOS™, a single API set may be provided for each platform. In Tizen™, two or more API sets may be provided.

The application 370 includes a home application 371, a dialer application 372, a short message service application (SMS)/multimedia message service (MMS) application 373, an instant message application (IM) 374, a browser application 375, a camera application 376, an alarm application 377, a contact application 378, a voice dial application 379, an electronic mail application (e-mail) 380, a calendar application 381, a media player application 382, an album application 383, a watch application 384, a health care application (e.g., measuring a momentum, a blood glucose or the like), and an environment information (e.g., air pressure, humidity, or temperature information) provision application. The application 370 may include an information exchange application capable of supporting information exchange between an electronic device and an external electronic device. The information exchange application may include a notification relay application for relaying specific information to the external electronic device, or a device management application for managing the external electronic device. The notification relay application may relay notification information provided in another application of the electronic device, to the external electronic device, or receive notification information from the external electronic device and provide the received notification information to a user. The device management application may install, delete, or refine a function (e.g., turned-on/turned-off of the external electronic device (or some components) or adjustment of a brightness (or resolution) of a display) of the external electronic device which communicates with the electronic device, or an application which operates in the external electronic device. The application 370 may include an application (e.g., a health care application of a mobile medical instrument) designated according to properties of the external electronic device. The application 370 may include an application received from the external electronic device. At least a part of the program module 310 may be implemented (e.g., executed) as software, firmware, hardware (e.g., the processor 210), or a combination of at least two or more of them, and may include a module for performing one or more functions, a program, a routine, sets of instructions or a process.

The electronic device 101 may include: the display 160; a biometric sensor (e.g., the biometric sensor 240I) disposed in at least a partial area of the display 160 (e.g., disposed under a display panel or included in a display panel); and at least one processor 120. The at least one processor 120 may be configured to perform: identifying attribute information associated with an event generated while the electronic device 101 operates in a low-power display mode; displaying a graphic object corresponding to the event on the partial area when the attribute information satisfies a designated condition; receiving a user input on the graphic object via the display 160; obtaining biometric information corresponding to the user input using the biometric sensor; and providing at least one content corresponding to the event when the biometric information is authenticated.

When the attribute information satisfies another designated condition, the at least one processor 120 may be configured to display another graphic object corresponding to the event on another partial area of the display 160.

The at least one processor 120 may be configured to perform: displaying a first designated screen corresponding to the event on at least a partial area of the display 160 when a user input on the another graphic object satisfies a first designated condition; and displaying a second designated screen corresponding to the event on at least the partial area when a user input on the another graphic object satisfies a second designated condition.

The at least one processor 120 may be configured to provide at least one other content corresponding to the event via the display 160, based on a user input on the another graphic object.

When at least partial content corresponding to the designated condition exists among at least one other content, the at least one processor 120 may be configured to display another graphic object corresponding to the at least partial content on the partial area of the display 160.

The at least one processor 120 may be configured to provide the at least one content in a state in which the low-power display mode is canceled.

The at least one processor 120 may be configured to receive a user input on the graphic object in a state of operating in the low-power display mode.

The at least one processor 120 may be configured to receive at least one of a touch input and a pressure input as a user input on the graphic object.

According to an embodiment, the at least one processor 120 may be configured to provide at least one content corresponding to the event via the electronic device 101 or another electronic device 102, 104, or 106 that is connected to the electronic device 101 via communication.

The electronic device 101 may include: the display 160 including a biometric sensor (e.g., a biometric sensor 240I) for obtaining biometric information in a designated area; at least one processor 120; and the memory 130 electrically connected with the at least one processor 120. According to an embodiment, the memory 130 may store instructions, and when the instructions are executed, the instructions enable the at least one processor to perform: detecting an event occurring while the electronic device operates in a low-power display mode; and displaying a graphic object corresponding to the event using the designated area when the event satisfies a designated condition.

The instructions may include an instruction to identify a user input on the graphic object and to authenticate the user using the biometric sensor.

The instructions may include an instruction to display a content corresponding to the event using the display 160 when the user is successfully authenticated.

The instructions may include an instruction to display a content corresponding to the event in the state of the low-power display mode when the event is designated to perform displaying in the state of the low-power display mode.

The instructions may include an instruction to display another graphic object corresponding to the event using another designated area of the display 160 when the event does not satisfy the designated condition.

The instructions may include an instruction to obtain a user input on the another graphic object, and to display a content corresponding to the event via the display 160, based at least on an attribute of the content.

When the content is designated to be output in the state in which the low-power display mode is canceled, the instructions may include an instruction to display the content in the state in which the low-power display mode is cancelled.

The instructions may include: an instruction to display a first designated content included in the content as the content when a user input for selecting the graphic object satisfies a first designated condition; and an instruction to display a second designated content included in the content as the content when a user input for selecting a first object satisfies a second designated condition.

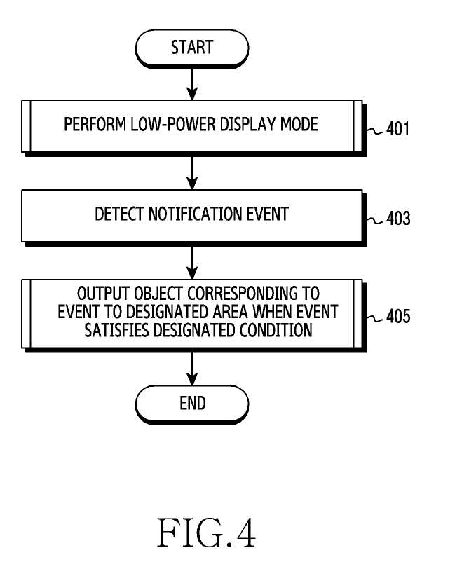

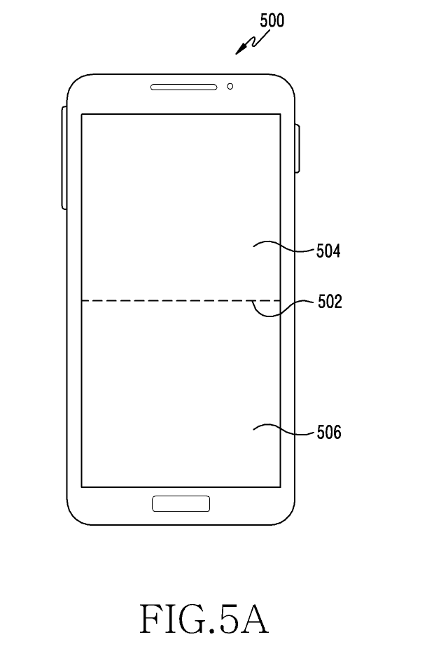

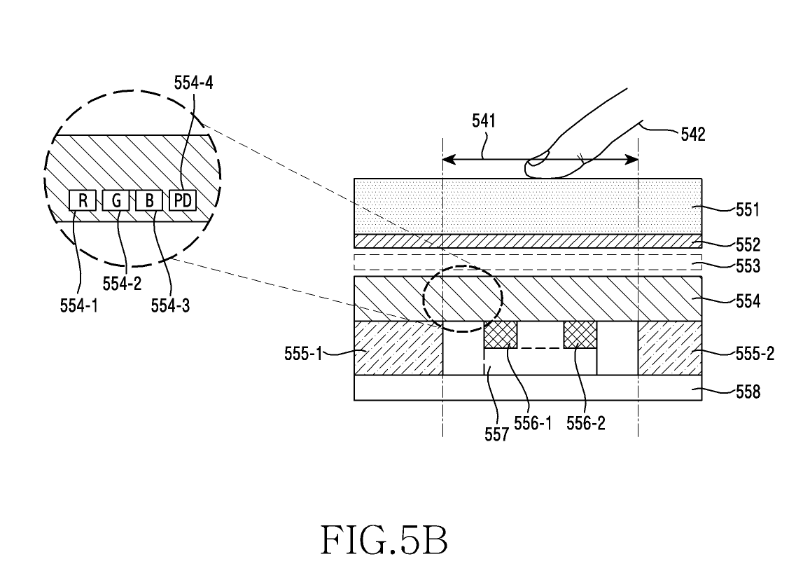

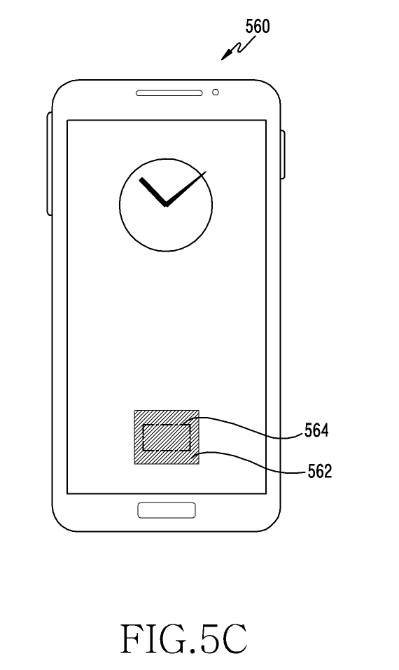

FIG. 4 is a flowchart of a method in which the electronic device 101 displays a content, according to an embodiment. FIGS. 5A to 5C are diagrams illustrating an area of a display where a content and/or an event notification object is output, according to an embodiment.

Referring to FIG. 4, in step 401, the processor 120 of the electronic device 101 performs a low-power display mode that outputs a predetermined designated content (e.g., an icon, an image, time information, weather information, date information, words designated by a user, schedule information, or the like) via the display 160, while the processor 120 maintains a sleep state of the electronic device 101. The electronic device 101 may output a designated content using an always-on-display function.

In step 403, the processor 120 detects the occurrence of an event while the low-power display mode is executed. The electronic device 101 may detect the occurrence of an event associated with at least one from among reception of a message, reception of an e-mail, a missed call, a schedule alarm, connection to a neighboring device (e.g., connection to a BT device, connection to a wireless LAN, or the like).

In step 405, when the detected event satisfies a designated condition, the processor 120 outputs a notification object corresponding to the event to a designated area of the display 160. The event that satisfies the designated condition may be an event that requires user authentication when the event is identified. The event that requires user authentication may include reception of a message, reception of an e-mail, a missed call, a schedule alarm, or the like.

The designated area of the display 160 may include a first area 504 of the display 160 and a second area 506 of the display 160, which are an upper area and a lower area distinguished based on a boundary 502, as shown in diagram 500 of FIG. 5A. The designated area may become narrowed or widened based on the location of the boundary 502. The location of the boundary 502 may be determined based on a user input. The location of the boundary 502 may be determined based on the number of notification objects corresponding to an event that satisfies a designated condition and may be output via the display 160. As the number of notification objects increases, the designated area where the notification objects are output may become widened. Although not illustrated, the first area 504 and the second area 506 of the display 160 may be separated into diagonal areas or the left and right areas based on a boundary, which may be curved.

As illustrated in FIG. 5B, the electronic device 101 may include, in a partial area of the display 160, at least one biometric sensor 553, 554-4, and 557 (e.g., a fingerprint recognition sensor) for detecting biometric information of a user. The biometric sensors 553, 554-4, and 557 may include an optical scheme-based image sensor, an ultrasonic scheme-based transmission/reception module, or a capacitive scheme-based transmission/reception electrode pattern. The biometric sensors 553, 554-4, and 557 may be disposed in various locations around the display panel 554 included in the electronic device 101.

For example, the biometric sensor 553 may be disposed between a window 551 (e.g., a front-side plate, a glass plate, etc.) and the display panel 554. The biometric sensor 553 may be disposed between the window 551 and the display panel 554 by being attached using an optical bonding member 552 (e.g., OCA (Optically Clear Adhesive) or PSA (Pressure Sensitive Adhesive)). The biometric sensor 553 may include a photo detection member (e.g., a photo sensor) that may receive light reflected by a fingerprint formed on a finger of a user that approaches the window 551. The reflected light may include light omitted from the display panel 554 or light emitted from a light source (e.g., IR LED) included in the biometric sensor 553. The biometric sensor 554-4 may be disposed in the display panel 554 and around at least one pixel including at least one sub-pixel 554-1, 554-2, and 554-3 of the display panel 554. The biometric sensor 554-4 may include a photo detection member (e.g., a photo sensor (photo diode (PD)) formed together with the at least one sub-pixels 554-1, 554-2, and 554-3. The photo detection member may receive light reflected by the fingerprint formed on the finger of a user that approaches the window 551. The reflected light may include light emitted from the at least one sub-pixel 554-1, 554-2, and 554-3 of the display panel 554. The biometric sensor 557 may be disposed in a first side (e.g., the rear side) of the display panel 554 and between the display panel 554 and a PCB 558, which can be disposed below the display panel.

The biometric sensor 557 may be disposed in a space formed by at least one structure 555-1 and 555-2 (e.g., a housing, a busing, etc.) disposed between the display panel 554 and the PCB 558. The at least one structure 555-1 and 555-2 may include a closed or sealed structure to protect the biometric sensor 557. Buffer members 556-1 and 556-2 (e.g., sponge, rubber, urethane, or silicon) may be interposed between the display panel 554 and the biometric sensor 557. The buffer member 556-1 and 556-2 may act as a mutual buffer between the display panel 554 and the biometric sensor 557, and may perform a dustproof function or an anti-fouling function. The biometric sensor 557 may include an image sensor that may detect light (e.g., visible rays, infrared rays, or ultraviolet rays) that is reflected by a fingerprint of a user after being emitted from a light source (e.g., the display panel 554 or the IR LED).

As illustrated in diagram 560 of FIG. 5C, a designated area 564 of the display 160 may be an area where a sensor 562 for obtaining biometric information is disposed.

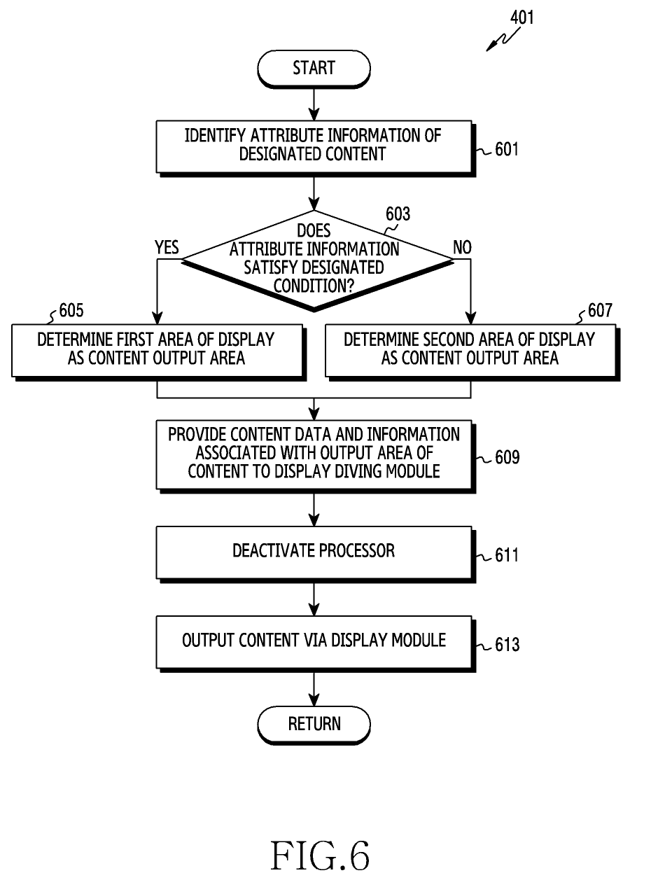

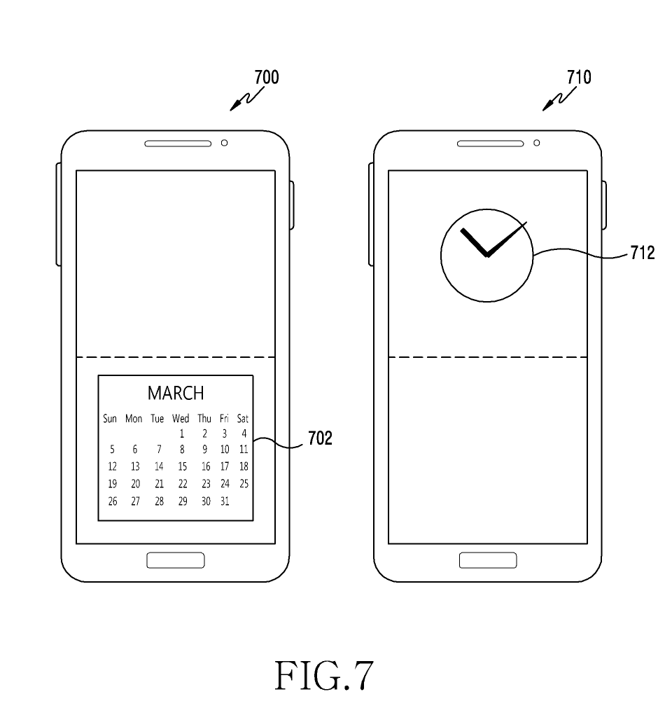

FIG. 6 is a flowchart of a method in which the electronic device 101 executes a low-power display mode, according to an embodiment. FIG. 7 is a diagram of an output area of a content that is designated to be output via the low-power display mode, according to an embodiment. The method of performing the low-power display mode may be used in conjunction with step 401 of FIG. 4.

Referring to FIG. 6, in step 601, the processor 120 identifies attribute information associated with a content that is designated to be output in the low-power display mode. The attribute information may be associated with the security level of the content. The security level of the content may be designated by a user or may be set based on the attribute of the content (e.g., whether to access personal information or the like).

In step 603, the processor 120 determines whether the attribute information of the designated content satisfies a designated condition. The fact that the designated condition is satisfied may indicate that the designated content has a security level at which authentication is required for executing the designated content.

When a content that satisfies the designated condition (or a content having a security level at which authentication is required) is designated, the processor 120 determines a first area of the display 160 as the output location of the designated content 702 in step 605. The first area of the display 160 may be a designated partial area of the display 160 to which a content having a security level that requires authentication is to be output. When schedule information that satisfies the designated condition is designated as illustrated in diagram 700 of FIG. 7, the processor 120 may output the content 702 corresponding to the schedule information to the first area.

When a content that does not satisfy the designated condition (or a content having a security level that does not require authentication) is designated, the processor 120 determines a second area of the display 160 as the output location of the designated content 712 in step 607. The second area of the display 160 may be another designated partial area of the display 160 to which a content having a security level that does not require authentication is to be output. When time information that does not satisfy the designated condition is designated as illustrated FIG. 7, the processor 120 outputs the content 712 corresponding to the time information to the second area.

In step 609, the processor 120 provides the designated content and information associated with the output area of the content to the display driving module 161. The designated content and the information associated with the output area of the content may be stored in the memory 163 of the display 160.

In step 611, the electronic device 101 switches the state of the processor 120 from the wake-up state to the sleep state.

In step 613, the display driving module 161 outputs the content via the display 160. Based on content output information, the display driving module 161 may provide an image signal corresponding to the content stored in the memory 163 to the display panel 166.

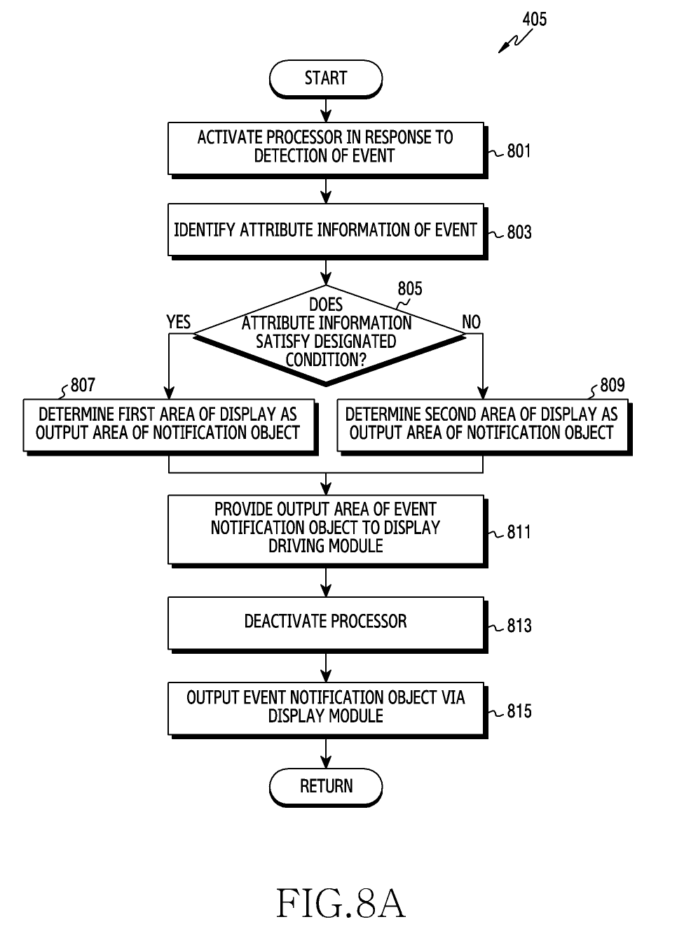

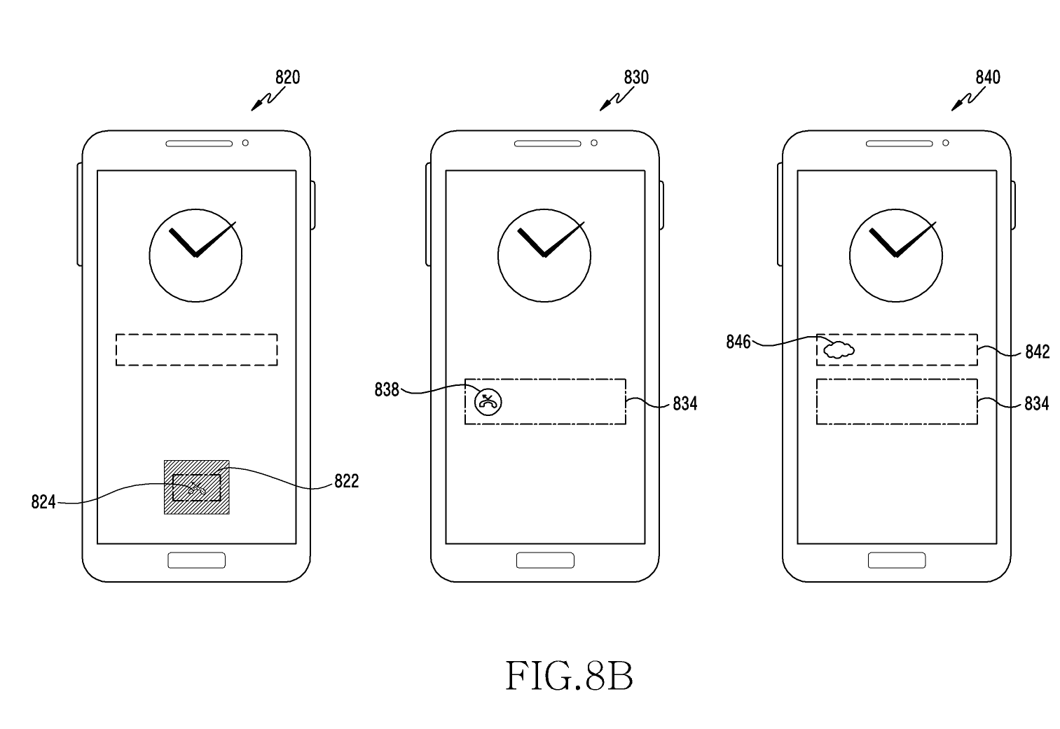

FIG. 8A is a flowchart of a method in which the electronic device 101 identifies an output area of an event notification object, according to an embodiment. FIG. 8B is a diagram of an output area of an event notification object, according to an embodiment. The procedure of identifying the output area of the event notification object may be used in conjunction with step 405 of FIG. 4.

Referring to FIG. 8A, the electronic device 101 may switch the state of the processor 120 from the sleep state to the wake-up state in response to detection of an event.

In step 803, the processor 120 identifies the attribute information of the detected event. The attribute information of the event may be associated with the security level of the event.

In step 805, the processor 120 determines whether the attribute information of the detected event satisfies a designated condition. The fact that the designated condition is satisfied may indicate that an event that requires authentication when the event is identified is detected.

When the event that satisfies the designated condition is detected, the processor 120 determines a first area of the display 160 as an output area of an event notification object in step 807. The first area of the display 160 may be a designated partial area of the display 160 to which a notification object corresponding to an event that requires authentication is to be output or may be a biometric information obtaining area of the display 160. When a missed call event that satisfies the designated condition is detected as illustrated in diagram 820 of FIG. 8B, the processor 120 may output a notification object 824 provided in a graphic form corresponding to the missed call event to a first area 822 of the display 160, which is designated as a biometric information obtaining area. When a missed call event that satisfies the designated condition is detected as illustrated in diagram 830 of FIG. 8B, he processor 120 may output a notification object 838 provided in a graphic form corresponding to the missed call event to a first area 834 of the display 160, which is designated as a partial area of the display 160.

When an event that does not satisfy the designated condition is detected, the processor 120 determines a second area of the display 160 as an output area of an event notification object in step 809. The second area of the display 160 may be another designated area of the display 160 to which a notification object corresponding to an event that does not require authentication is to be output. When a weather event that satisfies the designated condition is detected as illustrated in FIG. 8B, the processor 120 outputs a notification object 846 provided in a graphic form corresponding to the weather event to a second area 842, which is designated as another area distinct from the first area 834 of the display 160.

In step 811, the processor 120 provides information associated with the output area of the event notification object to the display driving module 161. The processor 120 provides information associated with the event notification object and information associated with the output area to the display driving module 161. The information associated with the event notification object and the information associated with the output area may be stored in the memory 163 of the display 160.

In step 813, the electronic device 101 transmits the information associated with the event notification object and the information associated with the output area, and may switch the state of the processor 120 from the wake-up state to the sleep state.

In step 815, the display driving module 161 outputs the event notification object via the display 160. Based on the information associated with the output area, the display driving module 161 may provide an image signal corresponding to the event notification object stored in the memory 163 to the display panel 166.

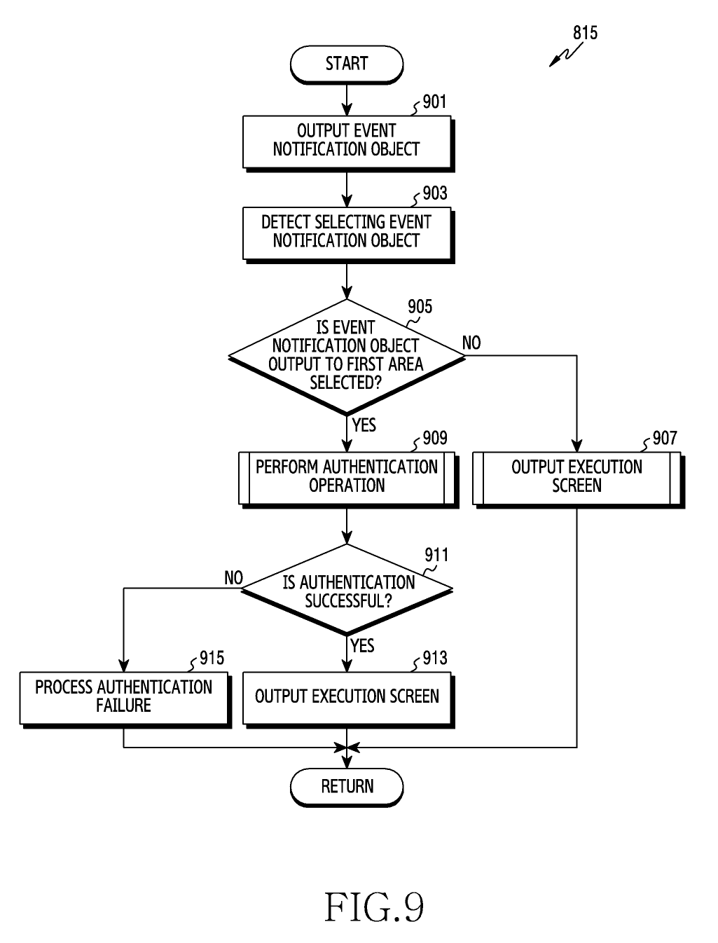

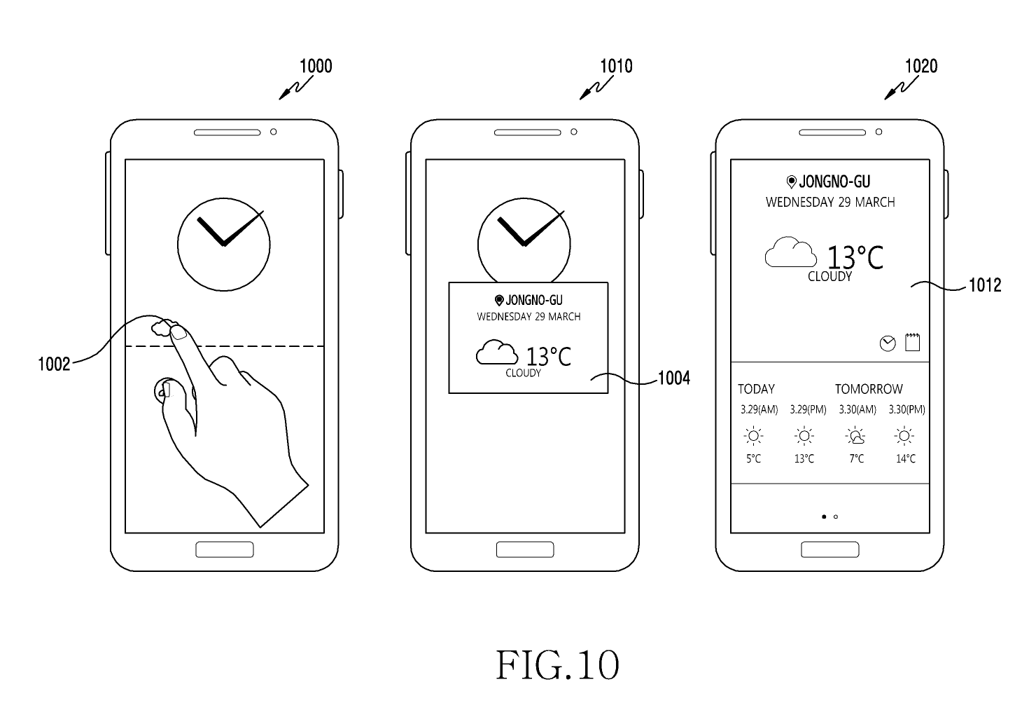

FIG. 9 is a flowchart of a method in which the electronic device 101 processes an event notification object, according to an embodiment. FIG. 10 is a diagram of processing a notification object that does not require authentication, according to an embodiment. The procedure of processing the event notification object may be used in conjunction with step 815 of FIG. 8A.

Referring to FIG. 9, the display driving module 161 outputs an event notification object via a low-power display mode in step 901. The notification object may include a notification object corresponding to an event that requires authentication when the event is identified and a notification object corresponding to an event that does not require authentication when the event is identified. The display driving module 161 may output, to a first area of the display 160, a notification object associated with an event that requires authentication when the event is identified. The display driving module 161 may output, to a second area distinct from the first area of the display 160, a notification object associated with an event that does not require authentication when the event is identified.

In step 903, the touch panel driving module 152 detects an input for selecting an event notification object. The touch panel driving module 152 may detect the input for selecting the event notification object in the state in which the low-power display mode is executed. Detecting the input may include obtaining coordinate information at which the input on the touch panel 154 is detected. The touch panel driving module 152 may provide the obtained coordinate information to the processor 120.

In step 905, the processor 120 determines which of the event notification object output to the first area and the event notification object output to the second area is selected based on the detected input. The processor 120 may be switched from the sleep state to the wake-up state for determination.

When the event notification object output to the second area is selected, the processor 120 outputs a content associated with the selected notification object in step 907. The content associated with the notification object may be an execution screen of the event. The execution screen may be output via the low-power display mode.

As illustrated in diagram 1000 of FIG. 10, when a weather event notification object 1002 output to the second area is selected, the processor 120 may output weather information 1004 associated with the current location or a designated location via the low-power display mode as shown in diagram 1010 of FIG. 10. When an additional input (e.g., a touch input) on the weather information output via the low-power display mode is detected, the processor 120 may cancel the low-power display mode and may output additional information 1012 (e.g., weekly weather) associated with the current location or the designated location as shown in diagram 1020 of FIG. 10. The processor 120 may provide data associated with the execution screen to the display driving module 161. The processor 120 may provide the data associated with the execution screen to the display driving module 161, and may be switched into a sleep state.

Referring again to FIG. 9, when the event notification object output to the first area is selected, the processor 120 performs an authentication operation in step 909. The authentication operation may be performed via a screen for receiving input of authentication information corresponding to a set authentication scheme (e.g., a pattern authentication scheme, an iris authentication scheme, a fingerprint authentication scheme, a password authentication scheme, etc.). The authentication operation may be performed at the same time at which user input that is input on the first area is obtained in step 905. When the set authentication scheme is a fingerprint authentication scheme, the processor 120 may use a fingerprint sensor disposed in the first area, instead of separately output a screen for obtaining input for authentication, whereby an authentication operation with respect to the obtained information on the finger of the user may be performed.

In step 911, the processor 120 identifies the result of the authentication operation. The authentication result may indicate whether the received authentication information and authentication information stored in the electronic device 101 are identical.

When the authentication operation is successfully performed, the processor 120 outputs a content associated with the selected notification object in step 913. The content associated with the notification object may be an execution screen of the event. The execution screen may be output in the state in which the low-power display mode is canceled. The processor 120 may output the execution screen associated with the notification object via an external device (e.g., a wearable device). The processor 120 may change the output execution screen into the form of audio data and may output the same.

When the authentication operation fails, the processor 120 processes authentication failure in step 915. Processing the authentication failure may include outputting a message indicating the authentication failure. The message indicating the authentication failure may be output via a screen, in the form of audio data, or in the form of vibration.

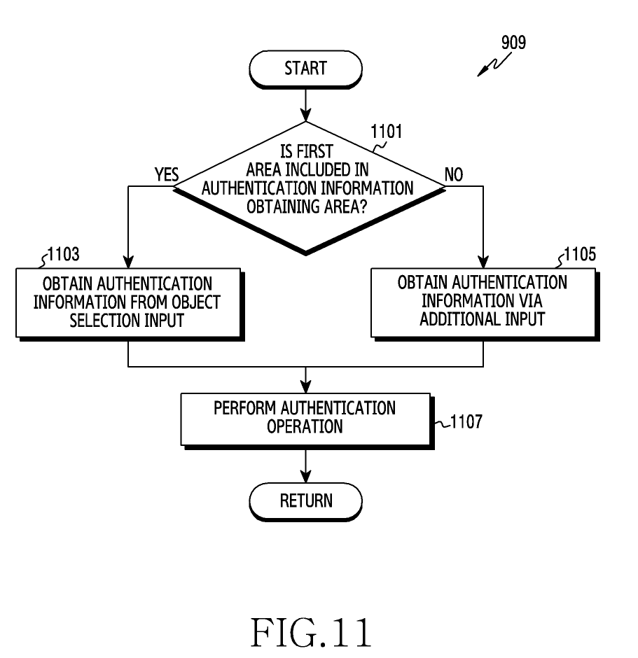

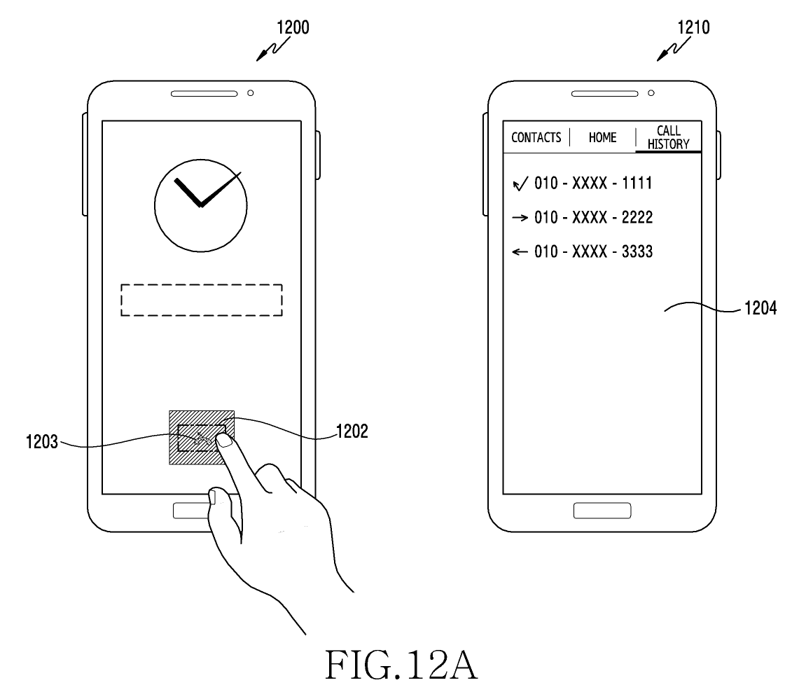

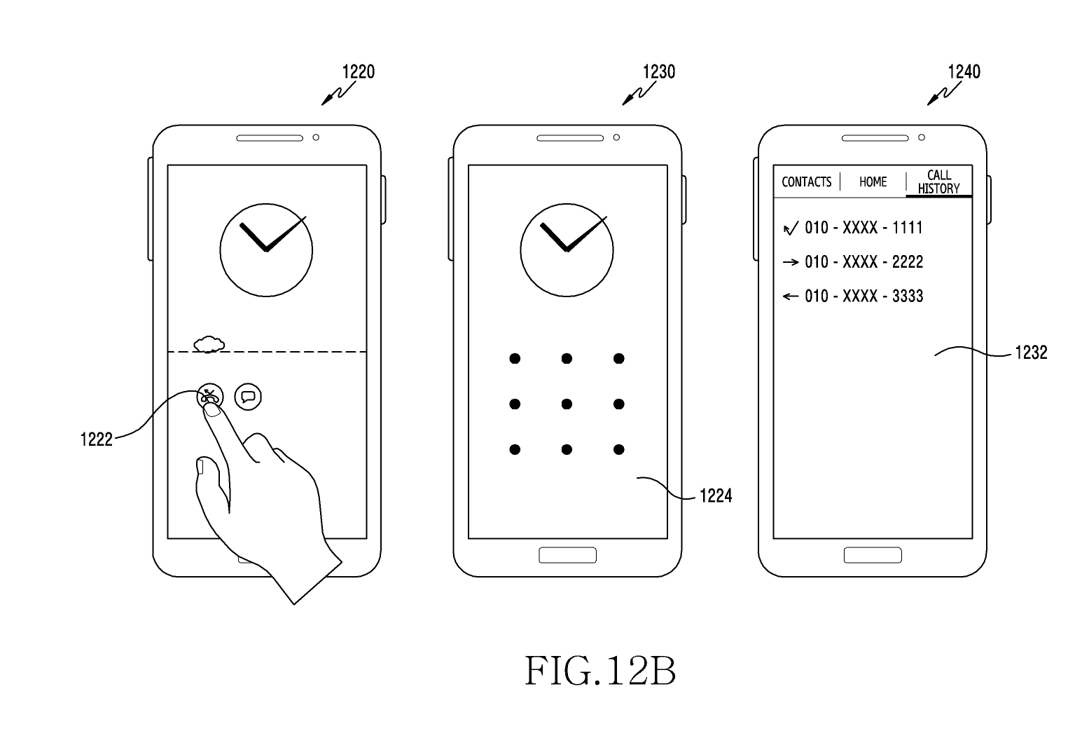

FIG. 11 is a flowchart of a method in which the electronic device 101 processes an event notification object that requires authentication, according to an embodiment. FIGS. 12A and 12B are diagrams of a notification object that requires authentication, according to an embodiment. The procedure of processing the event notification object that requires authentication may be used in conjunction with step 909 of FIG. 9.

Referring to FIG. 11, in step 1101, the processor 120 determines whether a designated area (e.g., a first area) to which a notification object corresponding to an event that requires authentication is to be output is included in an authentication information obtaining area of the display 160.

When the designated area to which a notification object is to be output is included in the authentication information obtaining area, the processor 120 obtains authentication information from an input for selecting an event notification object in step 1103. The input for selecting the event notification object may be input detected in step 903 of FIG. 9. For example, as illustrated in diagram 1200 of FIG. 12A, when a notification object 1203 (e.g., a missed call notification object) included in an authentication information obtaining area 1202 is selected, the processor 120 may obtain authentication information from an input for selecting the object.

When the designated area to which a notification object is to be output is not included in the authentication information obtaining area, the processor 120 obtains authentication information from an additional input in step 1105. The additional input may be obtained via an authentication screen (e.g., a pattern authentication screen, a fingerprint authentication screen, an iris authentication screen, or the like). For example, as illustrated in diagram 1220 of FIG. 12B, when a notification object 1222 (e.g., a missed call notification object) that is not included in the authentication information obtaining area is selected, the processor 120 may output an authentication screen 1224 for obtaining authentication information, as illustrated in diagram 1230 of FIG. 12B.

In step 1107, the processor 120 performs an authentication operation using the authentication information obtained via the object selection input or the additional input. The authentication operation may be an operation of determining whether the authentication information obtained from the object selection input or the additional input is identical to authentication information stored in the electronic device 101. When authentication is successfully performed via the authentication operation, the processor 120 may output an execution screen 1204 and 1232 associated with the selected notification object, as illustrated in diagram 1210 of FIG. 12A and diagram 1240 of FIG. 12B.

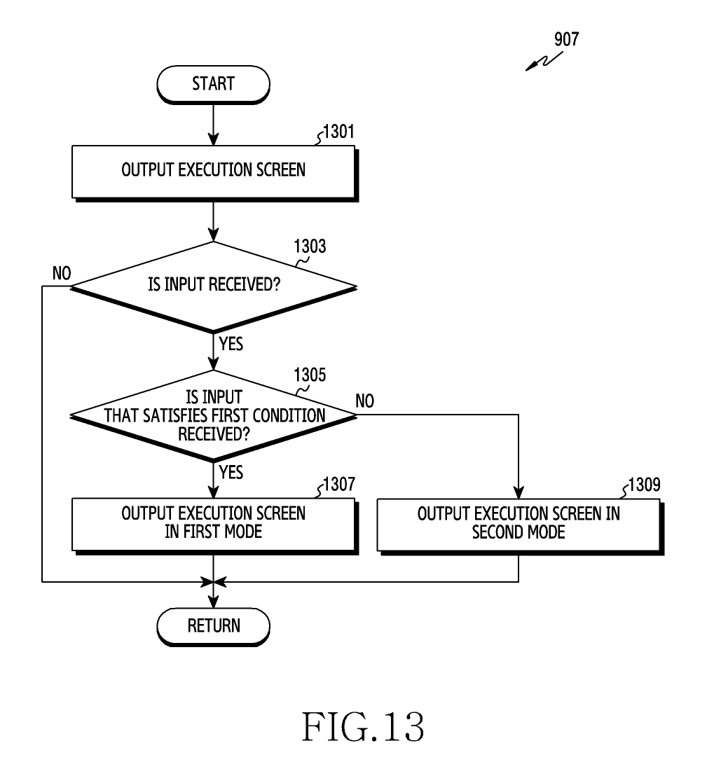

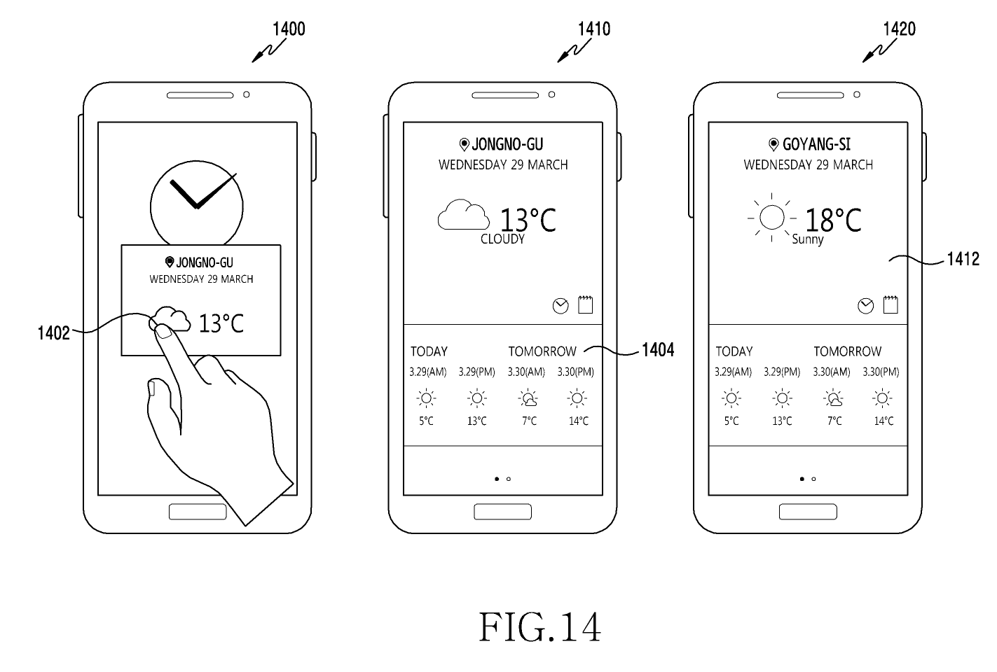

FIG. 13 is a flowchart of a method in which the electronic device 101 controls an execution screen, according to an embodiment. FIG. 14 is a diagram of a screen output based on input on an execution screen, according to an embodiment. The procedure of controlling an execution screen may be used in conjunction with step 907 of FIG. 9.

Referring to FIG. 13, in step 1301, the display driving module 161 outputs an execution screen via a low-power display mode. The processor 120 may maintain a sleep state while the execution screen is output via the low-power display mode.

In step 1303, the touch panel driving module 152 determines whether input is received in the state in which the execution screen is output. The input may be a touch input on the execution screen. The input may be a pressure input on the execution screen. The processor 120 may be switched from the sleep state to the wake-up state in response to the reception of the input.

When the input is received, the processor 120 determines which of input satisfying a first condition and input satisfying a second condition is received in step 1305. The first condition may be a condition (e.g., an input time, the number of times that input is provided, the intensity of input, etc.) for outputting a first execution screen. The second condition may be a condition (e.g., an input time, the number of times that input is provided, the intensity of an input, etc.) for outputting a second execution screen. The first execution screen and the second execution screen may provide different pieces of information. The first execution screen may be a screen that provides a relatively smaller amount of information than that of the second execution screen.

When an input that satisfies the first condition is received, the processor 120 outputs the first execution screen in step 1307. For example, when input 1402 that satisfies the first condition is received in diagram 1400 of FIG. 14, the processor 120 may output a screen 1404 that provides weather information of a first region, as illustrated in diagram 1410 of FIG. 14.

When an input that satisfies the second condition is received, the processor 120 outputs the second execution screen in step 1309. For example, when input that satisfies the second condition is received in diagram 1400 of FIG. 14, the processor 120 may output a screen 1412 that provides weather information of a second region, as illustrated in diagram 1420 of FIG. 14.

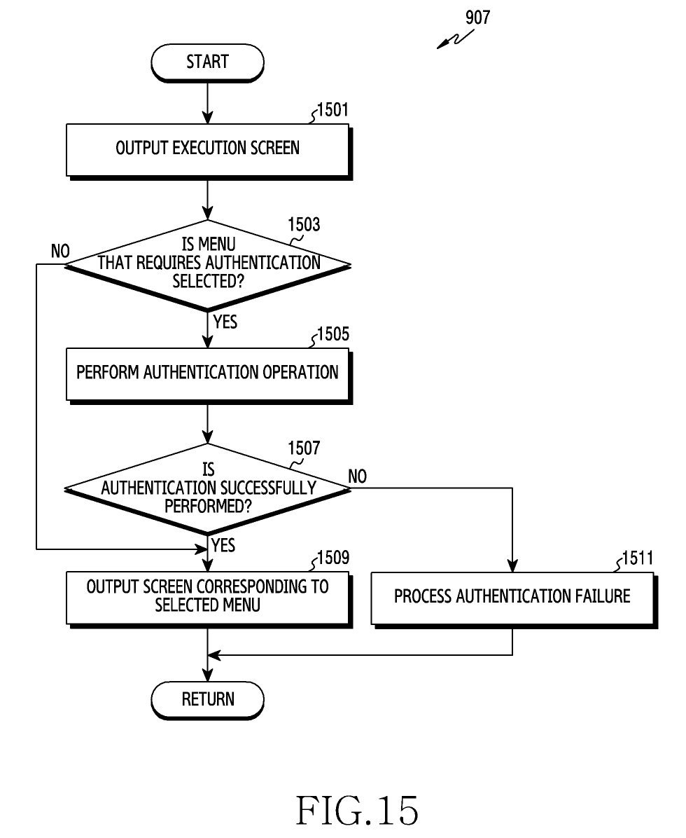

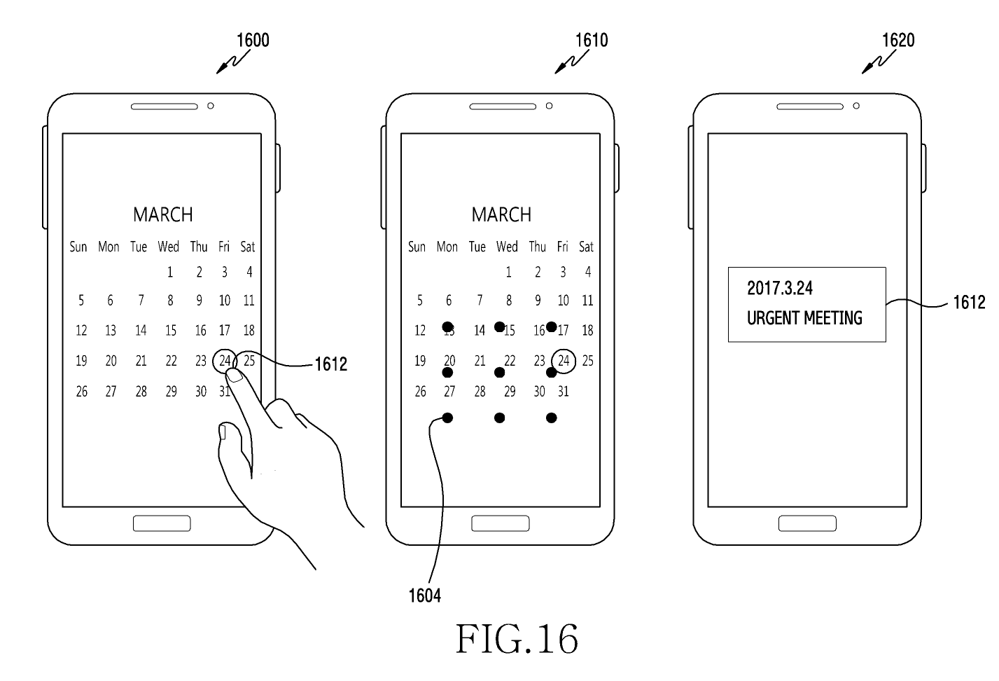

FIG. 15 is a flowchart of a method in which the electronic device 101 controls an execution screen, according to an embodiment. FIG. 16 is a diagram illustrating a screen output based on input on an execution screen, according to an embodiment. The procedure of controlling the execution screen may be used in conjunction with step 907 of FIG. 9.

Referring to. FIG. 15, in step 1501, the display driving module 161 outputs an execution screen via a low-power display mode. The processor 120 may maintain a sleep state while the execution screen is output via the low-power display mode.

In step 1503, the processor 120 determines whether a menu that requires authentication is selected. The menu that requires authentication may be a menu that calls a screen (e.g., a payment screen, a personal information input screen, or the like) that allows only an authenticated user access. The screen that allows only the authenticated user access may include a user interface (or GUI) for accessing personal information stored in the electronic device 101.

When a menu that does not require authentication is selected, the processor 120 or the display driving module 161 may output a screen corresponding to the selected menu in operation 1509. The screen corresponding to the selected menu may be output via the low-power mode. The screen that corresponds to the selected menu may be output in the state in which the low-power mode is canceled.

When a menu that requires authentication is selected, the processor 120 performs an authentication operation in step 1505. The authentication operation may be performed via a screen for receiving input of authentication information corresponding to a set authentication scheme (e.g., a pattern authentication scheme, an iris authentication scheme, a fingerprint authentication scheme, a password authentication scheme, etc.). For example, when a menu 1612 that requires authentication is selected as illustrated in_diagram 1600 of FIG. 16, the processor 120 may output a screen 1604 for receiving input of a pattern as illustrated in diagram 1610 of FIG. 16.

In step 1507, the processor 120 identifies the result of the authentication operation. The processor 120 may determine whether the received authentication information is identical to stored authentication information.

When the authentication operation is successfully performed, the processor 120 outputs a screen corresponding to the selected menu in step 1509. The screen corresponding to the selected menu 1612 may be output in the state in which the low-power display mode is canceled as illustrated in diagram 1620 of FIG. 16.

When the authentication operation fails, the processor 120 processes the authentication failure in step 1511. The authentication failure may be processed by outputting a message indicating authentication failure to a screen.

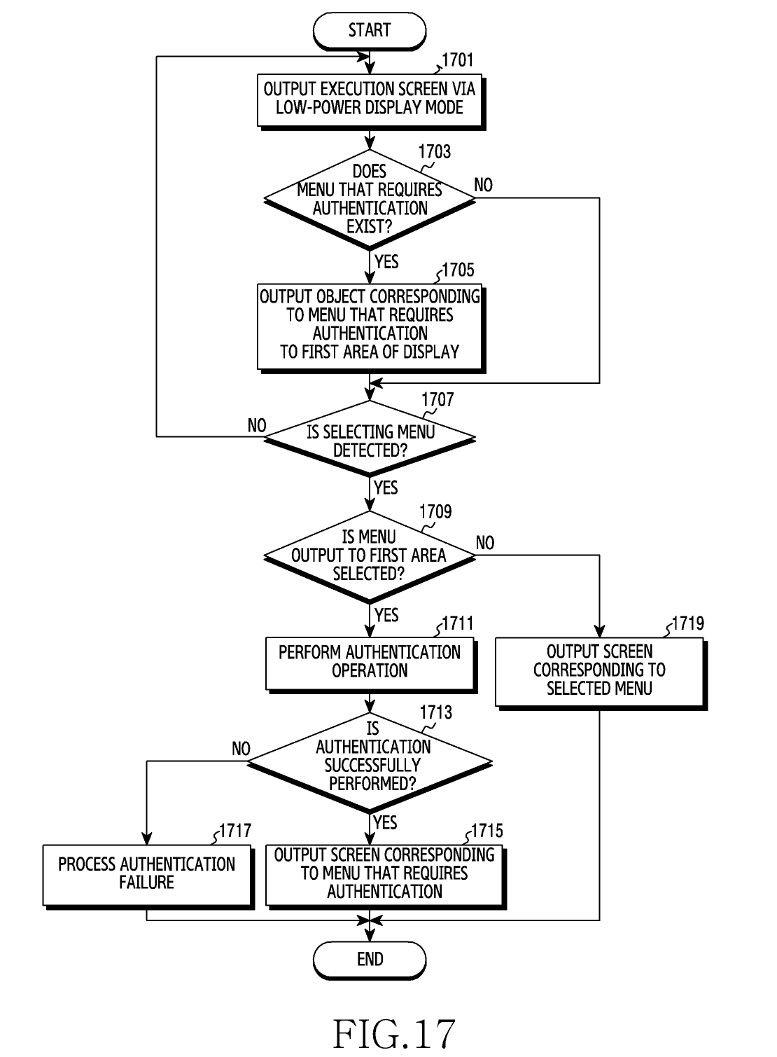

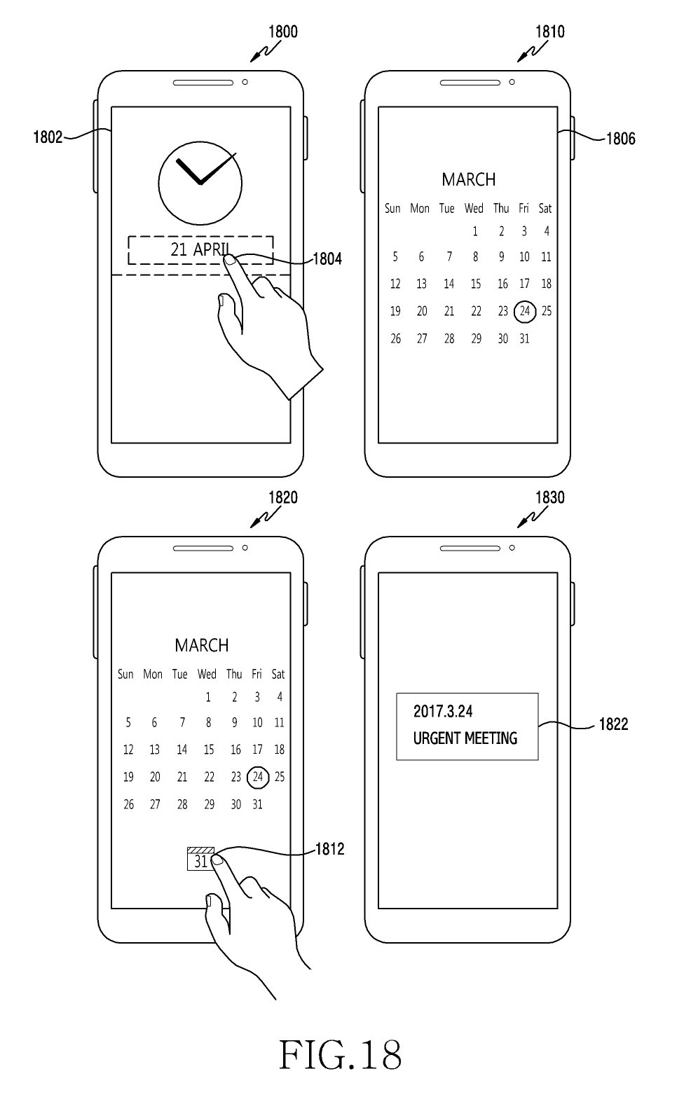

FIG. 17 is a flowchart of a method in which the electronic device 101 controls an execution screen, according to an embodiment. FIG. 18 is a diagram illustrating a situation in which an execution screen is output, according to an embodiment.

Referring to FIG. 17, in step 1701, the display driving module 161 outputs an execution screen via a low-power display mode. The execution screen may be a screen 1806 that is output as illustrated in diagram 1810 of FIG. 18, as a content or notification object 1804 output via the low-power display mode 1802 is selected, as illustrated in diagram 1800 of FIG. 18. The output screen may include at least one menu that calls a screen that is different from the current screen.

In step 1703, the processor 120 determines whether a menu that requires authentication exists in the execution screen. The menu that requires authentication may be a menu that calls a screen that allows only an authenticated user access (e.g., a payment screen, personal information input screen, or the like).

When the menu that requires authentication exists, the processor 120 outputs an object corresponding to the menu that requires authentication to a first area of the display 160 in step 1705, as illustrated in diagram 1820 of FIG. 18. The first area of the display 160 may be an area where a sensor for obtaining biometric information is disposed.

In step 1707, the processor 120 determines whether input for selecting at least one menu included in the execution screen is detected.

When the input for selecting the menu is not detected, the display driving module 161 maintains outputting of the execution screen. For example, the display driving module 161 may perform an operation associated with step 1701.

When the input for selecting the menu is detected, the processor 120 determines whether a menu output to the first area is selected in step 1709. The menu output to the first area may be a menu that calls a screen that allows only an authenticated user access.

When a menu that is not output to the first area is selected, the processor 120 outputs a screen corresponding to the selected menu in step 1719. The screen corresponding to the selected menu may be output via the low-power mode.

When a menu 1812 output to the first area is selected, the processor 120 performs an authentication operation in step 1711. The authentication operation may be performed using authentication information obtained via input for selecting the menu output to the first area.

In step 1713, the processor 120 identifies the result of the authentication operation. The authentication result may indicate whether the received authentication information and authentication information stored in the electronic device 101 are identical.

When the authentication is successfully performed, the processor 120 outputs a screen 1822 corresponding to the selected menu in step 1715, as illustrated in diagram 1830 of FIG. 18. The execution screen may be output in the state in which the low-power display mode is canceled.

When the authentication operation fails, the processor 120 processes authentication failure in step 1717. Processing the authentication failure may be an operation of outputting a message indicating the authentication failure.

A method of the electronic device 101 may include: detecting an event occurring while the electronic device 101 operates in the low-power display mode; and displaying a graphic object corresponding to the event using a designated area of the display 160 including a biometric sensor for obtaining biometric information when the event satisfies a designated condition.

The method of the electronic device 101 may include: identifying a user input on the graphic object; and authenticating the user using the biometric sensor.

The method of the electronic device 101 may include: displaying another graphic object corresponding to the event using another designated area of the display when the event does not satisfy a designated condition.

An electronic device that uses one or more of the methods described herein may omit an authentication operation with respect to at least a content having a security level that does not requires authentication from among contents output via the low-power display mode, whereby a user may quickly access a desired function.

At least a part of an apparatus (e.g., modules or functions thereof) or method (e.g., operations) described herein may be implemented as an instruction which is stored in a non-transitory computer-readable storage medium (e.g., the memory 130) in the form of a program module. In response to the instruction being executed by a processor (e.g., the processor 120 of FIG. 1A or the processor 210 of FIG. 2), the processor may perform a function corresponding to the instruction.

The non-transitory computer-readable recording medium may include a hard disk, a floppy disk, a magnetic medium (e.g., a magnetic tape), an optical recording medium (e.g., a compact disk ROM (CD-ROM), a digital versatile disk (DVD)), a magneto-optical medium (e.g., a floptical disk), an internal memory, etc. The instruction may include a code which is made by a compiler or a code which is executable by an interpreter. The module or program module may include at least one or more of the aforementioned constituent elements, or omit some of them, or further include another constituent element. Operations carried out by the module, the program module or the another constituent element may be executed in a sequential, parallel, repeated or heuristic manner, or at least some operations may be executed in different order or may be omitted, or another operation may be added.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. An electronic device, comprising:
a display;
a biometric sensor disposed in at least a partial area of the display; and
a processor configured to:
identify attribute information associated with an event generated while the electronic device operates in a low-power display mode;
display a graphic object corresponding to the event on the partial area when the attribute information satisfies a designated condition;
receive a user input on the graphic object via the display;
obtain biometric information corresponding to the user input using the biometric sensor; and
provide at least one content corresponding to the event when the biometric information is authenticated.

2. The electronic device of claim 1, wherein, when the attribute information satisfies another designated condition, the processor is further configured to display another graphic object corresponding to the event on another partial area of the display.

3. The electronic device of claim 2, wherein the processor is further configured to:
display a first designated screen corresponding to the event on at least a partial area of the display when a user input on the another graphic object satisfies a first designated condition; and
display a second designated screen corresponding to the event on at least the partial area when a user input on the another graphic object satisfies a second designated condition.

4. The electronic device of claim 2, wherein the processor is further configured to provide at least one other content corresponding to the event via the display based on a user input on the another graphic object.

5. The electronic device of claim 4, wherein, when at least partial content corresponding to the designated condition exists among at least one other content, the processor is further configured to display another graphic object corresponding to the at least partial content on the partial area of the display.

6. The electronic device of claim 1, wherein the processor is further configured to provide the at least one content in when the low-power display mode is canceled.

7. The electronic device of claim 1, wherein the processor is further configured to receive a user input on the graphic object when operating in the low-power display mode.

8. The electronic device of claim 1, wherein the processor is further configured to receive, as a user input on the graphic object, at least one of a touch input and a pressure input.

9. The electronic device of claim 1, wherein the processor is further configured to provide at least one content corresponding to the event via the electronic device or another electronic device that is connected to the electronic device via communication.

10. An electronic device, comprising:
a display comprising a biometric sensor for obtaining biometric information in a designated area; and
a processor electrically connected to a memory and configured to detect an event while the electronic device operates in a low-power display mode and display a graphic object corresponding to the event using the designated area when the event satisfies a designated condition.

11. The electronic device of claim 10, wherein the processor is further configured to identify a user input on the graphic object and to authenticate a user using the biometric sensor.

12. The electronic device of claim 11, wherein the processor is further configured to display a content corresponding to the event using the display when the user is successfully authenticated.

13. The electronic device of claim 12, wherein the processor is further configured to display a content corresponding to the event in the low-power display mode.

14. The electronic device of claim 10, wherein the processor is further configured to display another graphic object corresponding to the event using another designated area of the display when the event does not satisfy the designated condition.

15. The electronic device of claim 14, wherein the processor is further configured to obtain a user input on the another graphic object, and to display a content corresponding to the event via the display based at least on an attribute of the content.

16. The electronic device of claim 15, wherein the processor is further configured to display the content when the low-power display mode is cancelled.

17. The electronic device of claim 14, wherein the processor is further configured:
to display a first designated content included in the content as the content when a user input for selecting the graphic object satisfies a first designated condition; and
to display a second designated content included in the content as the content when a user input for selecting a first object satisfies a second designated condition.

18. A method of an electronic device, the method comprising:
detecting an event occurring while the electronic device operates in a low-power display mode; and
displaying a graphic object corresponding to the event using a designated area of a display, of the electronic device, comprising a biometric sensor for obtaining biometric information when the event satisfies a designated condition.

19. The method of claim 18, further comprising:
identifying a user input on the graphic object; and
authenticating a user using the biometric sensor.

20. The method of claim 18, further comprising:
displaying another graphic object corresponding to the event using another designated area of the display when the event does not satisfy the designated condition.
